(19) United States
(12) Patent Application Publication
(10) Pub. No.: US 2023/0399938 A1
(43) Pub. Date: Dec. 14, 2023

(54) REAL-TIME SCALE PRECIPITATION PREDICTION AND CONTROL SYSTEMS AND METHODS

(71) Applicant: Cameron International Corporation, Houston, TX (US)

(72) Inventors: Miguel Angel Hernandez de la Bastida, Houston, TX (US); Saniya Karnik, Houston, TX (US); Michael Van Spankeren, Houston, TX (US); Antonio Massoni Abinader, Houston, TX (US); David Orta, League City, TX (US); Adelola Obisanya, Cypress, TX (US)

(21) Appl. No.: 18/249,094

(22) PCT Filed: Oct. 12, 2021
(86) PCT No.: PCT/US2021/054512

§ 371 Date: Apr. 14, 2023

Related U.S. Application Data
(60) Provisional application No. 63/198,366, filed on Oct. 14, 2020.
(60) Provisional application No. 63/238,975, filed on Aug. 31, 2021.

(51) Int. Cl. E21B 47/00; E21B 37/06; E21B 47/06

(52) U.S. Cl. CPC E21B 47/006; E21B 37/06; E21B 47/06; E21B 2200/22

(57) ABSTRACT

Systems and methods presented herein generally relate to receiving real-time data from one or more sensors associated with equipment of a hydrocarbon well production system, predicting scale precipitation in the hydrocarbon well production system based at least in part on the real-time data, and automatically adjusting one or more operating parameters of the equipment based at least in part on the predicted scale precipitation. For example, automatically adjusting the one or more operating parameters of the equipment may include determining a scale inhibitor injection rate setpoint based at least in part on the predicted scale precipitation, and automatically adjusting a speed of one or more chemical injection pumps of a chemical injection system in accordance with the scale inhibitor injection rate setpoint.

### CROSS-REFERENCES TO RELATED APPLICATIONS

This application claims priority to and the benefit of U.S. Provisional Patent Application Ser. No. 63/198,366, entitled “Real-Time Scale Precipitation Prediction System and Method,” filed Oct. 14, 2020, and U.S. Provisional Patent Application Ser. No. 63/238,975, entitled “Autonomous Corrosion and Scale Management in Electric Submersible Pump Wells,” filed Aug. 31, 2021, both of which are hereby incorporated by reference in their entireties for all purposes.

### BACKGROUND

The present disclosure generally relates to real-time systems and methods for prediction of scale precipitation in a hydrocarbon well's production system.

This section is intended to introduce the reader to various aspects of art that may be related to various aspects of the present techniques, which are described and/or claimed below. This discussion is believed to be helpful in providing the reader with background information to facilitate a better understanding of the various aspects of the present disclosure. Accordingly, it should be understood that these statements are to be read in this light, and not as an admission of any kind.

Oil and gas producers extract oil, gas, and water from subsurface reservoirs, and transport them to surface for commercial sales. Throughout the process, there may be issues encountered that hinder liquid flow or cause negative impacts on downhole equipment (e.g., electric submersible pumps (ESP)). These flow assurance issues can cause flow hindrance in the production system leading to production losses and may pose risks to the integrity of the production system. A known flow assurance issue is the deposition of scale forming minerals. Predicting the presence of such mineral depositions inside a production system transporting hydrocarbons may allow for proactive chemical intervention to avoid scale related flow assurance issues.

Scale deposition on the components of the production system can be mitigated by injecting chemicals, like scale inhibitors, to limit the precipitation or deposition of solids or by “pigging operations” to remove the deposit from the pipe surface. Scale inhibitors may be injected continuously from the surface or dispersed periodically directly into the reservoir. Such operations might be planned based on fluid characterization, predictive models, and production observations. However, advanced prediction might enable better definition of chemical injection and cleaning operations and facilitate assessment of their efficiency.

### SUMMARY

A summary of certain embodiments described herein is set forth below. It should be understood that these aspects are presented merely to provide the reader with a brief summary of these certain embodiments and that these aspects are not intended to limit the scope of this disclosure.

Certain embodiments of the present disclosure include a scale prediction and control system that includes one or more processors and storage media comprising processor-executable instructions that, when executed by the one or more processors, cause the one or more processors to receive real-time data from one or more sensors associated with equipment of a hydrocarbon well production system; to predict scale precipitation in the hydrocarbon well production system based at least in part on the real-time data; and to automatically adjust one or more operating parameters of the equipment based at least in part on the predicted scale precipitation.

Certain embodiments of the present disclosure also include a method that includes receiving, via a scale prediction and control system, real-time data from one or more sensors associated with equipment of a hydrocarbon well production system. The method also includes predicting, via the scale prediction and control system, scale precipitation in the hydrocarbon well production system based at least in part on the real-time data. The method further includes automatically adjusting, via the scale prediction and control system, one or more operating parameters of the equipment based at least in part on the predicted scale precipitation.

Certain embodiments of the present disclosure include a scale prediction and control system that includes one or more processors and storage media comprising processor-executable instructions that, when executed by the one or more processors, cause the one or more processors to receive real-time data from one or more sensors associated with equipment of a hydrocarbon well production system; utilize cloud-based computing software to predict scale precipitation in the hydrocarbon well production system based at least in part on the real-time data; and to automatically adjust one or more operating parameters of the equipment based at least in part on the predicted scale precipitation.

Various refinements of the features noted above may be undertaken in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings, in which:

FIG. 1 illustrates a production system that includes a continuous chemical injection system and an electric submersible pump configured to inject chemicals into a well, in accordance with embodiments of the present disclosure;

FIG. 2 illustrates a control system that may include a scale prediction and control system to control the production system of FIG. 1, in accordance with embodiments of the present disclosure;

FIG. 3 is a flow diagram of an iteration of a workflow for scale prediction and control of the production system of FIG. 1 (e.g., using the scale prediction and control system of FIG. 2), in accordance with embodiments of the present disclosure;

FIG. 4 illustrates a representation of a neural network based real-time scale prediction algorithm workflow (e.g., which may be implemented by the scale prediction and control system of FIG. 2), in accordance with embodiments of the present disclosure;

FIG. 5 illustrates an example of a real-time scale formation prediction using live (e.g., real-time) data of downhole pressure and temperature, in accordance with embodiments of the present disclosure;

FIG. 6 illustrates a method used in chemical injection operations using the scale prediction and control system of FIG. 2, in accordance with embodiments of the present disclosure;

FIG. 7 illustrates a workflow for determining a target corrosion inhibitor injection rate, and setting the determined target corrosion inhibitor injection rate in the chemical injection system, in accordance with embodiments of the present disclosure;

FIG. 8 illustrates a workflow for determining a target scale inhibitor injection rate, and setting the determined target scale inhibitor injection rate in the chemical injection system, in accordance with embodiments of the present disclosure; and

FIG. 9 is a flow diagram of a method for using the scale prediction and control system of FIG. 2, in accordance with embodiments of the present disclosure.

### DETAILED DESCRIPTION

One or more specific embodiments of the present disclosure will be described below. These described embodiments are only examples of the presently disclosed techniques. Additionally, in an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features.

As used herein, the terms “connect,” “connection,” “connected,” “in connection with,” and “connecting” are used to mean “in direct connection with” or “in connection with via one or more elements”; and the term “set” is used to mean “one element” or “more than one element.” Further, the terms “couple,” “coupling,” “coupled,” “coupled together,” and “coupled with” are used to mean “directly coupled together” or “coupled together via one or more elements.”

In addition, as used herein, the terms “real time”, “real-time”, or “substantially real time” may be used interchangeably and are intended to describe operations (e.g., computing operations) that are performed without any human-perceivable interruption between operations. For example, as used herein, data relating to the systems described herein may be collected, transmitted, and/or used in control computations in “substantially real time” such that data readings, data transfers, and/or data processing steps occur once every second, once every 0.1 second, once every 0.01 second, or even more frequent, during operations of the systems (e.g., while the systems are operating). In addition, as used herein, the terms “continuous”, “continuously”, or “continually” are intended to describe operations that are performed without any significant interruption. For example, as used herein, control commands may be transmitted to certain equipment every five minutes, every minute, every 30 seconds, every 15 seconds, every 10 seconds, every 5 seconds, or even more often, such that operating parameters of the equipment may be adjusted without any significant interruption to the closed-loop control of the equipment. In addition, as used herein, the terms “automatic”, “automated”, “autonomous”, and so forth, are intended to describe operations that are performed are caused to be performed, for example, by a computing system (i.e., solely by the computing system, without human intervention).

Certain embodiments of the present disclosure provide scale precipitation predictions including using real-time data throughout the lifetime of a well. In certain embodiments, the real-time data may include pressure and temperature gathered using sensors installed throughout a production system. In addition, in certain embodiments, the real-time data may include water chemical properties and water rate. For example, water rate might be provided using virtual flow models or flow meters. In addition, in certain embodiments, the real-time data may include data inferred from machine learning models using simulation algorithms. In addition, in certain embodiments, the machine learning model estimates the flow rate using inputs from the submersible pump live data and reservoir data. In certain embodiments, a second machine learning model is a neural network model that computes saturation index and scale precipitation using data coming from a submersible pump, surface sensors, and the output of the first machine learning model.

In certain embodiments, the systems and methods described herein include control logic to calculate a chemical inhibitor injection rate based on the results of the machine learning model. In addition, in certain embodiments, the control logic module provides automated remote control on a chemical injection equipment. In addition, in certain embodiments, the control logic communicates with a chemical injection equipment controller to automatically adjust the chemical injection rate. In addition, in embodiments, the control logic synchronizes the operation of the chemical injection equipment with a corresponding submersible pump status.

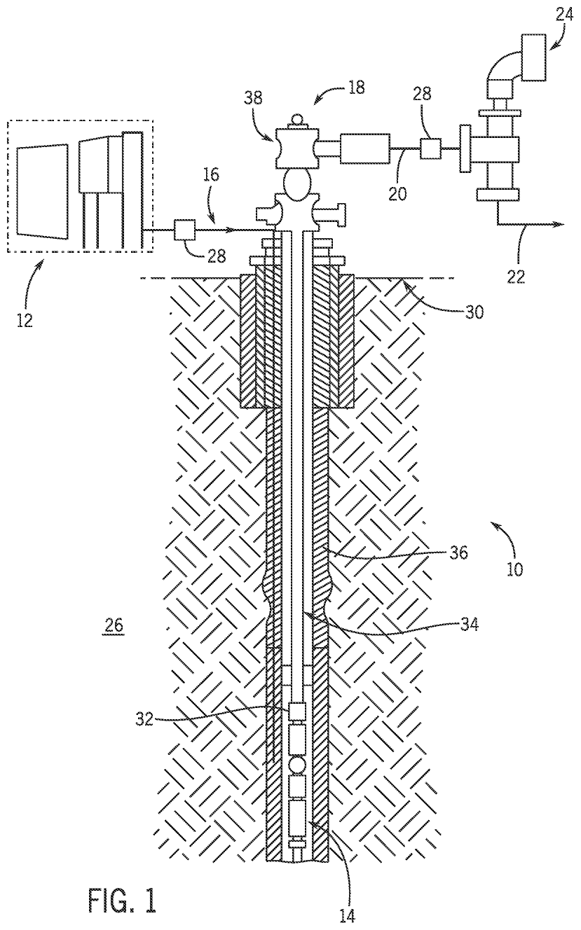

With the foregoing in mind, chemical intervention is a common way of proactively preventing the deposition of scale. FIG. 1 illustrates a production system 10 that includes a continuous chemical injection system 12 and an electric submersible pump 14 configured to inject chemicals 16 into a well 18. As illustrated in FIG. 1, the chemicals 16 may be injected into the well 18 from the chemical injection system 12 and produced fluid 20 (e.g., produced oil, gas, and water) returning from the well 18 may flow back through a surface flowline 22, as controlled by a choke 24. The chemicals 16 injected by the chemical injection system 12 may be referred to as scale inhibitors. It should be noted that, in other embodiments, scale inhibitors may also be dispersed periodically directly into the reservoir 26 (e.g., scale squeeze) via the well 18.

Regardless of which chemical application methods are being used, understanding the tendency of scale formation in the system 10 is fundamental to prescribe the correct scale inhibition concentration and methodology. Because there are no commercially available methods to measure scale deposition rate directly in the system 10, software packages may be developed to predict the likelihood and rate of scale deposition. In these software packages, certain variables may be entered as static inputs representative of certain operating parameters. The outputs of the software packages may then be used to determine optimal concentrations of injection (e.g., minimum effective dosage (MED)) of the chemicals 16 based on the severity of the predicted values. An objective is to keep the production system 10 continuously protected against the formation of scale. The inputs for the software packages are often only available sporadically and might include, in certain embodiments:
1. Changes in the scale-forming ion concentrations in the produced fluid 20 (e.g., notably the water) including, but not limited to, barium, calcium, sulfate, bicarbonate, and so forth. These ions are generally assumed to be relatively static in a healthy system and are measured by physically taking a sample of the produced water, delivering it to a laboratory, and having it analyzed using specific equipment.
2. Acid gas concentrations (e.g., carbon dioxide (CO₂) and hydrogen sulfide (H₂S)) coming from gas analyses of the produced fluid 20. These acid gas concentrations may be used to estimate pH in the system 10 along with temperature and pressure, which may generally be collected annually. The pH of the sampled fluids is often taken immediately after collection to complement the analysis.
3. Oil, gas, and water flow rates of the produced fluid 20 from the well 18 that typically come in the form of well test data. These flow rates are generally obtained monthly or quarterly using either multi-phase flow meters, biphasic or triphasic separators, metering tanks, and so forth.
4. Temperature and pressure changes measured with surface sensors 28 and/or downhole sensors 32.

The prescribed chemical concentration, also known as the Minimum Effective Concentration (MIC) is set at the time the chemical program is being designed. In general, the MIC needs to be maintained for the chemicals to be effective in protecting the well against asset integrity and flow assurance issues. In certain embodiments, the MIC may be converted into a target injection rate using a simple formula shown below.

TGT=0.000042*Q_{w}*TC
where:
TGT=Target Inhibitor Injection Rate (in gallons per day)
Q_{w}=Produced Water Rate (in barrels per day)
TC=Target Inhibitor Concentration (in parts per million)

What is evident in the above formula is that the rate of water production from the well 18 is a key input into calculating the target injection rate of the chemicals 16. However, the target chemical injection rate is often recalculated infrequently because it is tied to availability of the latest information regarding changes in the rates of production from the well 18. In conventional scale prevention systems and methods, this data is typically obtained through well testing, which may be performed monthly, using multi-phase flow meters.

When new well test information becomes available, the chemical injection target calculation is run to determine the new target chemical injection rate that is appropriate based on the well test flow rate. The new target chemical injection rate is then manually adjusted by a field engineer by resetting the chemical injection pump rate (e.g., changing the pump speed or changing a flow adjusting valve). Because well tests are done on a relatively infrequent basis, the chemical injection rate is typically also reset only infrequently (e.g., monthly).

When characterizing scale and corrosion risk, changes in the chemical composition of the produced water are also important to understand. At the onset of a chemical program, samples of the produced water are typically taken and analyzed in a laboratory environment to establish a baseline. Table 1 presented below shows various sampling techniques that are often used. For example, periodically (e.g., every 2-3 months), new produced water samples are extracted and analyzed in the laboratory to compare to the pre-established baseline. The chemical composition of the water is expected to remain constant, and when it changes, it may be an indication of scale precipitating or corrosion/erosion occurring at some point in the well 18. This may necessitate an increase to the chemical concentration, to take a more aggressive approach to protecting the well 18.

TABLE 1
Various Sample Techniques and Associated Collection Frequencies

| Monitoring Method | Data Monitored | Frequency |
|---|---|---|
| Corrosion Coupon | Corrosion Rate, Metal Loss | 60-90 days |
| Scale Coupon | Relative Scale Deposition Rate | 60-90 days |
| Water Analysis | Changes in Water Chemical | 30-45 days |
| | Composition | |
| Inhibitor | Presence of Corrosion and | 30-45 days |
| Residuals | Scale Inhibiting Chemicals | |
| Well Test | Produced Fluid Rates | 15-30 days |

Finally, changes in temperature and pressure throughout the well 18 can also impact the likelihood of scale precipitating, but these values are typically measured at the surface 30, and recorded when water samples are extracted, or when new well tests are performed. Therefore, when considering the frequency of new data to calculate updated target injection rates in conventional scale prevention systems and methods, well tests are typically the most frequently monitored and, therefore, we can assume that new target injection rates are calculated at the same frequency of well tests. In addition, between well tests, no new flow rate information is available, so the flow rates from the well 18 are assumed to remain constant until a new well test is performed. Because of this, the “designed” target chemical injection rate is also constant during the interval between well tests.

The actual flow rate, however, does not remain constant and may gradually or abruptly change due to varying field operational conditions. Indeed, it has been observed that the actual flow rate for a given well 18 may vary between ranges where the highest flow rate during a year may be even an order of magnitude (or even more) greater than the lowest flow rate during the year. At any given time, if the actual flow rate is above the well test flow rate, the amount of chemicals 16 needed will be above the target chemical injection rate determined using well test data. This results in the potential of leaving the well 18 unprotected during the times between when well tests are executed, and prone to asset integrity and flow assurance issues.

In addition, since the input data is often collected only sporadically, and the scale prediction software is often run manually, scale predictions are also often sporadic and require relatively long engineering times. Such methods also assume a constant behavior during the time gaps where no data is available. However, the actual rate of scale deposition may not remain constant. In contrast, the actual rate of scale deposition may gradually or abruptly change due to fluctuating conditions of flow rate, temperature, pressure, and so forth. Indeed, it has been observed that over 50% of the time during a given year, the actual rate of scale deposition for a given well 18 indicates that chemicals 16 are either being over injected or under injected. Therefore, the actual rate of chemical injection is quite often above or below the minimum effective concentration, leading to a potential unprotected system 10 due to inadequate chemical concentration, or costly over-injection that increases operational expenses.

Furthermore, there is a challenge that using computational models for calculation of mineral saturation index (SI) and scale precipitation quantity estimates while correlating these results to what occurs in real time. In addition, these estimates are particularly more challenging when the inputs to these models are constantly changing. Currently, in systems where the inputs vary, computational models assume the most severe or extreme conditions since field analysis results used to input into the models are obtained sporadically. For this reason, the computational models may not always be accurate in time (e.g., differences between time of data gathering and analysis). Further challenges may be encountered with the cumbersome transfer of knowledge obtained from these models into databases. Also, such software solutions might present compatibility issues with each other and may be less likely to be scalable for cloud and edge deployments.

Therefore, in summary, conventional scale prevention systems and methods are often performed sub-optimally for several reasons including, but not limiting to:
Data Availability—updated well test data, temperature, and pressure changes, and chemical composition data are often available only at a maximum frequency of once per month.
Manual Chemical Adjustments—once new data is available that may necessitate a change to the chemical injection rate, a field engineer is still required to drive to the well location and manually adjust the chemical injection pumps.
Lack of Visibility on Chemical Injection Systems—chemical injection pumps can go down or lose efficiency for several reasons such as mechanical failure or factors such as gas accumulation in chemical injection lines. Because there are often hundreds of chemical injection pumps, and the wells are often in remote locations, issues with the chemical injection may often not be known for several days.

Embodiments described herein alleviate the shortcomings of such scale prevention systems and methods. In certain embodiments, the systems and methods described herein make use of both historical and real-time data along with deep learning and state-of-the-art computation techniques to create a real-time scale precipitation prediction system, enabling better surveillance options, and allowing optimum management. In addition, in certain embodiments, the systems and methods described herein may be used to assist with live scale prediction for downhole artificial lift applications, subsea production applications, and surface fluid processing equipment such as separators and water injection and/or disposal systems.

In addition, in certain embodiments, the systems and methods described herein reduce the likelihood of scale precipitation by considering instantaneous changes in pressure and temperature that normally occur throughout the lifetime of a well 18. In addition, in certain embodiments, the systems and methods described herein use data from deep learning models that use real-time data coming from surface sensors 28 (e.g., located at the surface 30 of the well 18) and/or downhole sensors 32 (e.g., disposed downhole within the wellbore 34 of the well 18, which may be defined by tubing 36 of the well 18) installed throughout the production system 10, real-time water rate calculations using virtual flow models, and water chemical properties to improve monitoring and continuous treatment of scale precipitation. In certain embodiments, the surface sensors 28 may be integrated with certain equipment (e.g., of the chemical injection system 12, the choke 24, a wellhead 38 of well 18, and so forth) at the surface 30 of the well 18. In addition, in certain embodiments, the downhole sensors 32 may be integrated with the electric submersible pump 14 or other downhole tools.

As such, the embodiments described herein make use of several additional sources of real-time information to better understand the performance of the combined chemical injection and hydrocarbon production system 10, and how to manage it optimally. Several aspects of the embodiments described herein collectively lead to distinct improvements over conventional scale prevention systems and methods including, but not limited to:
Connected Equipment—use of inline field measurement devices (e.g., the sensors 28, 32 described herein) that can provide real-time measurements of changes in key factors in the production system 10 that may impact the effectiveness of the chemical treatment. By communicating continuous measurements, they can be used as inputs into calculating an optimized chemical injection rate at a much higher frequency than conventional scale prevention systems and methods allow, thereby ensuring continuous protection and extending the run life of the electric submersible pump 14 and other downhole tools.
Real-Time Modeling—use of software containerized in an HoT (Industrial Internet of Things) gateway to calculate the variables needed by the optimization workflow that are not available through connected equipment. For example, virtual flow, scale prediction, and downhole corrosion are but a few of the models that may be used.
Edge Analytics and Computing—all of the acquired data from the connected equipment and models may be processed using the HoT gateway, to calculate a new optimized chemical injection rate.
Autonomous Control—once the new optimal chemical injection rate is determined, a closed loop control system send control signals to the chemical injection pumps of the chemical injection system 12 to inject chemicals 16 at the optimal chemical injection rate.

In addition, in certain embodiments, the systems and methods described herein are not only scalable and deployable in different environments, but also facilitates real-time predictions with higher accuracy that completely correlate in time (e.g., matching time of data gathering with data analysis as close as possible). In addition, in certain embodiments, the systems and methods described herein enable automation and closed loop control on the physical chemical injection process (e.g., performed by the chemical injection system 12) based on the use of real-time computational model data.

In addition, in certain embodiments, the systems and methods described herein may be applied to other sources of data with different chemical water properties, different scale species, and different SI calculation approaches. In addition, in certain embodiments, the systems and methods described herein may have both subsea or offshore application and enable the input from any component of the production system 10 where measurements of pressure and temperature are available. In addition, in certain embodiments, the systems and methods described herein may be integrated with network multi-phase simulators.

In addition, in certain embodiments, the systems and methods described herein gather field data from the studied reservoir 26. This information might include sensor data (e.g., collected by the surface sensors 28 and/or downhole sensors 32), well tests, and complete water analyses, among others. In certain embodiments, two kinds of raw data might be used: (1) real-time data and (2) sporadic data (i.e., data not collected in real time, but rather collected in long-time intervals, such as daily, weekly, monthly, or at even more sporadic time intervals). Real-time data generally comes from surface sensors 28 and/or downhole sensors 32 associated with equipment in the field, and sporadic data comes from an external, more time-consuming process such as lab analysis of collected samples. In certain embodiments, the systems and methods described herein may use the real-time data and the sporadic data to infer missing or hard-to-get data required for the workflow. In certain embodiments, domain knowledge may be used to facilitate such inference, for example, through the use of physics models and/or through the use of artificial intelligence. In certain situations, since monitoring surveys may only be conducted monthly, large amounts of data are not always available. Therefore, in certain embodiments, the systems and methods described herein may use synthetic data that will fit field data inside its limits and will account for all the possible expected scenarios. In certain embodiments, the generated data enters an automated workflow that runs scale modeling software and returns saturation index and precipitation mass per unit volume of water, as measured in milligrams per liter (mg/L).

In certain embodiments, generated simulation results may then be used as inputs into another automated workflow that may train deep learning models to reproduce saturation index and precipitation volume with relatively high accuracy. The purpose of this is to enable real-time computation in various environments independent of the specific type of the underlying software. Once running, the systems and methods described herein allow users to have real-time monitoring of protection of the production system 10 against scale precipitation at different analysis points (e.g., downhole, at the wellhead, as the surface facilities, and so forth) and may also trigger remote control of scale inhibitor chemical injection pumps of the chemical injection system 12, for example.

In certain embodiments, the systems and methods described herein include control logic to feed input data into real-time scale predictions and triggers automated control of the chemical injection system 12 (e.g., of the chemical injection pumps of the chemical injection system 12). This represents a significant advantage over conventional scale prediction methods, typically done on a much more infrequent (e.g., sporadic) basis, introducing the risk of not understanding or missing potential risk as it is occurring in real time. As such, the systems and methods described herein generate insights that are used to control actual equipment in the field. In certain embodiments, the systems and methods described herein implement a cyclic process such that, after the equipment in the field is being adjusted, the new data from live sources (e.g., real-time data) continues to guide the equipment, creating a self-correcting closed loop control.

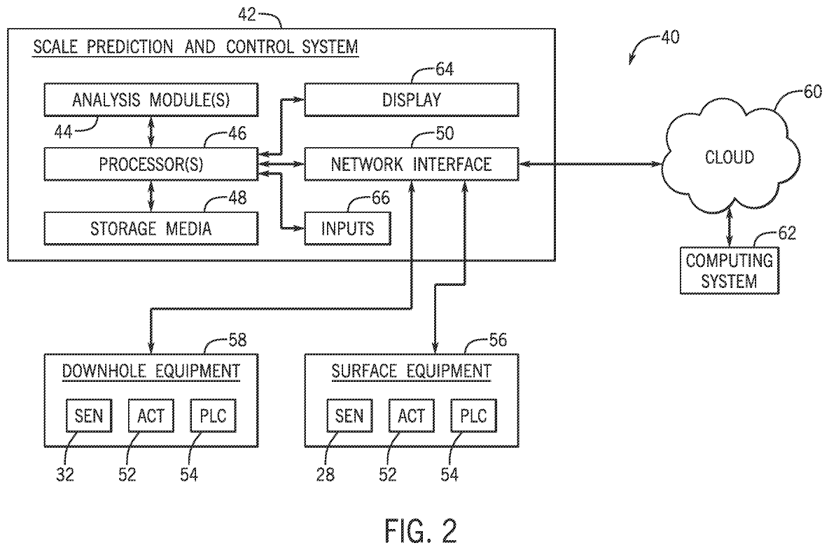

FIG. 2 illustrates a control system 40 that may include a scale prediction and control system 42 to control the production system 10 of FIG. 1 as described in greater detail herein. In certain embodiments, the scale prediction and control system 42 may include one or more analysis modules 44 (e.g., a program of processor executable instructions and associated data) that may be configured to perform various functions of the embodiments described herein. In certain embodiments, to perform these various functions, an analysis module 44 executes on one or more processors 46 of the scale prediction and control system 42, which may be connected to one or more storage media 48 of the scale prediction and control system 42. Indeed, in certain embodiments, the one or more analysis modules 44 may be stored in the one or more storage media 48.

In certain embodiments, the one or more processors 46 may include a microprocessor, a microcontroller, a processor module or subsystem, a programmable integrated circuit, a programmable gate array, a digital signal processor (DSP), or another control or computing device. In certain embodiments, the one or more storage media 48 may be implemented as one or more non-transitory computer-readable or machine-readable storage media. In certain embodiments, the one or more storage media 48 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the processor-executable instructions and associated data of the analysis module(s) 44 may be provided on one computer-readable or machine-readable storage medium of the storage media 48, or alternatively, may be provided on multiple computer-readable or machine-readable storage media distributed in a large system having possibly plural nodes. Such computer-readable or machine-readable storage medium or media are considered to be part of an article (or article of manufacture), which may refer to any manufactured single component or multiple components. In certain embodiments, the one or more storage media 48 may be located either in the machine running the machine-readable instructions, or may be located at a remote site from which machine-readable instructions may be downloaded over a network for execution.

In certain embodiments, the processor(s) 46 may be connected to a network interface 50 of the scale prediction and control system 42 to allow the scale prediction and control system 42 to communicate with the various surface sensors 28 and/or downhole sensors 32 described herein, as well as communicate with the actuators 52 and/or PLCs 54 of surface equipment 56 (e.g., the chemical injection system 12, the choke 24, the wellhead 38, and so forth) and/or of downhole equipment 58 (e.g., the electric submersible pump 14, other downhole tools, and so forth) for the purpose of controlling operation of the production system 10, as described in greater detail herein. In certain embodiments, the network interface 50 may also facilitate the scale prediction and control system 42 to communicate data to a cloud-based service 60 (or other wired and/or wireless communication network) to, for example, archive the data or to enable external computing systems 62 (e.g., cloud-based computing systems, in certain embodiments) to access the data and/or to remotely interact with the scale prediction and control system 42. For example, in certain embodiments, some or all of the analysis modules 44 described in greater detail herein may be executed via cloud and edge deployments.

In certain embodiments, the scale prediction and control system 42 may include a display 64 configured to display a graphical user interface to present results on the analysis described herein. In addition, in certain embodiments, the graphical user interface may present other information to operators of the equipment 56, 58 described herein. For example, the graphical user interface may include a dashboard configured to present visual information to the operators. In certain embodiments, the dashboard may show live (e.g., real-time) data as well as the results of the analysis described herein. In addition, in certain embodiments, predicted flowrates, saturation index, and scale precipitate amount, among other data, may be presented along with historical data.

In addition, in certain embodiments, the scale prediction and control system 42 may include one or more input devices 66 configured to enable the operators to, for example, provide commands to the equipment 56, 58 described herein. For example, in certain embodiments, the recommended pump rate may be continuously updated, and an operator may be presented with an option to override the recommendation and set the pump speed as the operator desires by, for example, manipulating the one or more input devices 66. In addition, in certain embodiments, the display 64 may include a touch screen interface configured to receive inputs from operators. For example, an operator may directly provide instructions to the chemical injection system 12 via the user interface, and the instructions may be output to a chemical injection pump of the chemical injection system 12 via a controller and a communication system of the equipment.

It should be appreciated that the control system 40 illustrated in FIG. 2 is only one example of a well control system, and that the control system 40 may have more or fewer components than shown, may combine additional components not depicted in the embodiment of FIG. 2, and/or the control system 40 may have a different configuration or arrangement of the components depicted in FIG. 2. In addition, the various components illustrated in FIG. 2 may be implemented in hardware, software, or a combination of both hardware and software, including one or more signal processing and/or application specific integrated circuits. Furthermore, the operations of the control system 40 as described herein may be implemented by running one or more functional modules in an information processing apparatus such as application specific chips, such as application-specific integrated circuits (ASICs), field-programmable gate arrays (FPGAs), programmable logic devices (PLDs), systems on a chip (SOCs), or other appropriate devices. These modules, combinations of these modules, and/or their combination with hardware are all included within the scope of the embodiments described herein.

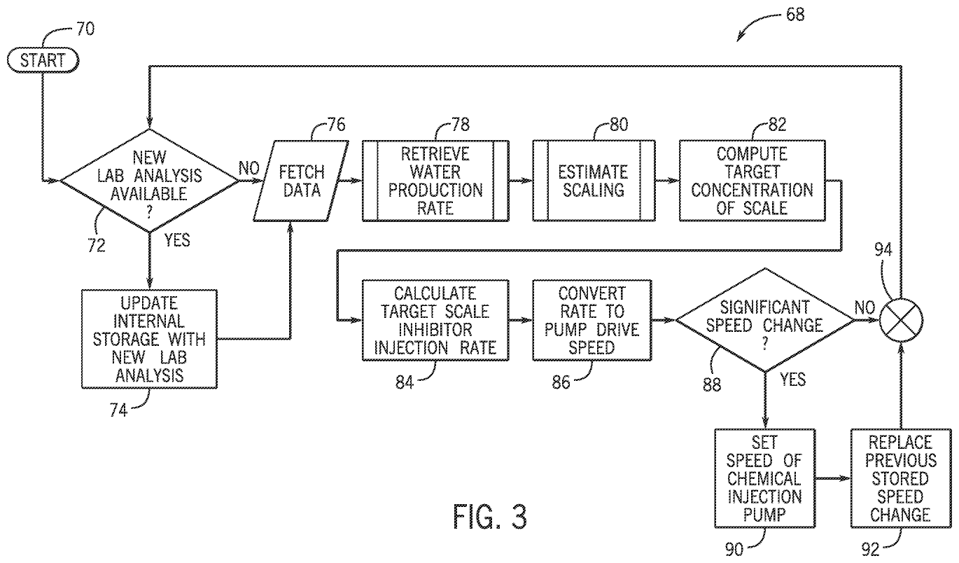

FIG. 3 is a flow diagram of an iteration of a workflow 68 for scale prediction and control of the production system 10 of FIG. 1 (e.g., using the scale prediction and control system 42 of FIG. 2). The workflow 68 may first start (block 70) and a determination of whether new lab analysis data is available (decision block 72). If new lab analysis data is available, internal storage may be updated with the new lab analysis data (block 74). In any event, data may be retrieved (block 76). Then, water production rate (e.g., of the produced fluid 20) may be retrieved (block 78). Then, based on the data, scaling may be predicted (block 80) and a target concentration of scale may be computed (block 82). Based on the predicted scaling and the target concentration of scale, and a target scale inhibitor injection rate may be calculated (block 84), and the target scale inhibitor injection rate may be converted into a pump drive speed (e.g., for a chemical injection pump of the chemical injection system 12) (block 86). Then, a determination may be made whether the pump drive speed represents a significant speed change (decision block 88). If the pump drive speed does, in fact, represent a significant speed change, then a speed of a chemical injection pump of the chemical injection system 12 may be set to the pump drive speed (block 90), and the previous stored speed change may be replaced in the internal storage (block 92). In any event, the workflow 68 stops at this point (block 94).

As such, in certain embodiments, when the control logic (e.g., of the workflow 68) starts/finishes an iteration, it checks for new input data (e.g., blocks 72, 74, 76, 78). If such data is available, it gets stored internally. After the data is stored, it is ready to be used in the next steps of the workflow 68. In certain embodiments, two models reside inside the control logic. In certain embodiments, the first model may comprise a machine learning model that estimates the flow rate using inputs from real-time data relating to the electric submersible pump 14 and the reservoir 26, which may be collected by downhole sensors 32, as described in greater detail herein. In addition, in certain embodiments, the second model may comprise a neural network model that computes saturation index and precipitation using real-time data relating to the electric submersible pump 14 and the reservoir 26, which may be collected by downhole sensors 32, as well as real-time data collected by surface sensors 28 and outputs of the first model as inputs to the second model.

In certain embodiments, the control logic (e.g., of the workflow 68) comprises a set of rules to calculate the new chemical inhibitor injection rate (e.g., block 84) based on the results of the first and second models. In particular, the control logic communicates with a controller of the chemical injection system 12 to automatically adjust a chemical injection rate provided by a chemical injection pump of the chemical injection system 12 (e.g., block 90). In certain embodiments, this communication includes unit conversion (e.g., block 86) to match the requirement of the controller of the chemical injection system 12 (e.g., revolutions per minute (RPMs), hertz (Hz), strokes per minute (SPMs), valve position, and so forth). In addition, in certain embodiments, the control logic (e.g., of the workflow 68) may automatically synchronize operation of the electric submersible pump 14 with the status of the chemical injection system 12. For example, in certain embodiments, the control logic (e.g., of the workflow 68) may start up or shut down the chemical injection system 12 to ensure, for example, a continuous injection during flowing conditions and avoiding injection while the well 18 is static.

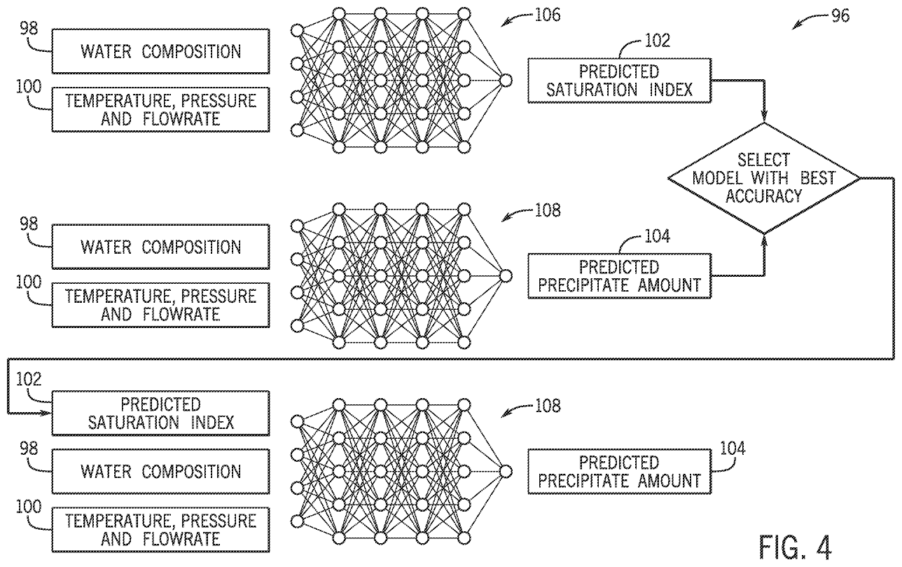

FIG. 4 illustrates a representation of a neural network-based real-time scale prediction algorithm workflow 96 (e.g., which may be implemented by the scale prediction and control system 42 of FIG. 2). As illustrated in FIG. 4, in certain embodiments, a neural network architecture enables real-time scale formation prediction in various digital environments (e.g., server(s), cloud, edge, local machine(s), and so forth) as opposed to conventional computation of scale prediction, which is currently limited to software running mainly on local machines. In certain embodiments, the workflow 96 includes first randomly splitting the dataset such that a percentage of the data might be used for training the neural network and the remaining portion might be used for testing the trained model. As illustrated, in certain embodiments, the inputs may include sporadic data 98 including, for example, water composition (e.g., obtained via laboratory testing of samples), as well as real-time data 100 (e.g., collected by the sensors 28, 32 described herein) including, for example, temperature, pressure, and flow rates. Once the training dataset is defined, each of the input features might be processed through hidden layers so they can be extracted and learned by the neural network. In addition, in certain embodiments, the training data set may further be split to generate a validation set, which may help to perceive the trend of the mean absolute error (MAE) while the algorithms learn, and to identify if the model is overfitting (i.e., learning from the same features repeatedly). Finally, in certain embodiments, a cascade neural network may be used to reduce the error on scale precipitate predictions.

As illustrated in FIG. 4, in certain embodiments, a scale prediction model may be used to simulate well conditions and determine two measurements: saturation index 102 and precipitate amount 104. In certain embodiments, the scale prediction model may be generated using a look-up table by permuting several randomly generated combinations of cases, and then training a neural network with it to enhance the capabilities of the software. In certain embodiments, the scale prediction model may include two neural networks: a first neural network 106 that predicts the saturation index 102 and a second neural network 108 that predicts the scale precipitate amount 104. Since both outputs are heavily correlated, in certain embodiments, they may be used in each other's respective neural networks as inputs. Whichever model (e.g., the first neural network 106 that predicts the saturation index 102 in the illustrated example) has a higher accuracy may then be used as the first predicted variable, and the results (e.g., the predicted saturation index 102 in the illustrated example) may then be fed into the other model (e.g., the second neural network 108 that predicts the scale precipitate amount 104 in the illustrated example), creating a cascading neural network. It will be appreciated that, in another example where the second neural network 108 has the higher accuracy, the scale precipitate amount 104 predicted by the second neural network 108 may instead be into the first neural network 106 to predict the saturation index 102 in a cascading manner.

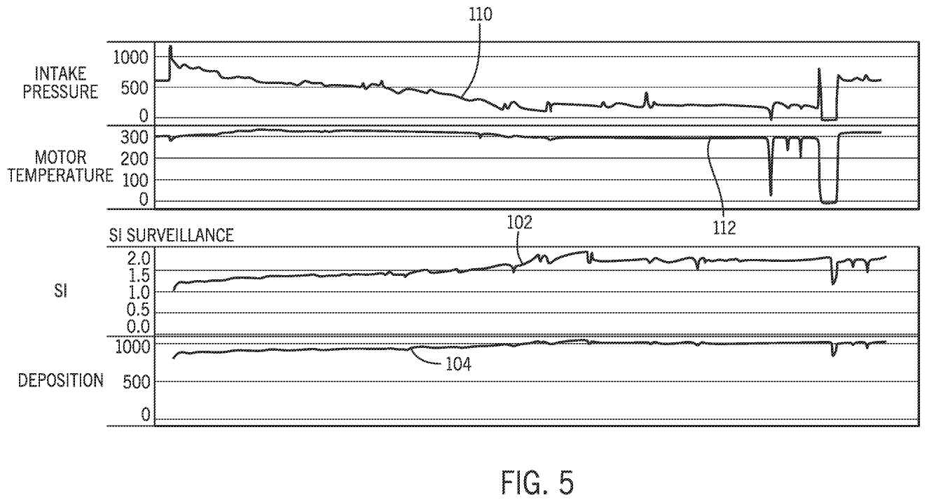

FIG. 5 illustrates an example of real-time scale formation predictions using live (e.g., real-time) data of downhole pressure 110 and temperature 112 (e.g., as collected by the sensors 28, 32 described herein). These variations may be picked by the models to generate real-time calculations of saturation index 102 and scale precipitate amount 104. Then, in certain embodiments, these outputs (e.g., saturation index 102 and scale precipitate amount 104) may be used by the scale prediction and control system 42 described herein to enable automated remote control on a chemical injection equipment (e.g., the chemical injection system 12), as described in greater detail herein.

As such, the embodiments described herein enable computation in any environment, providing real-time highly accurate scale formation prediction, closed loop control on chemical injection equipment, and continuous and efficient chemical treatment. The embodiments described herein also provide significant benefit over known prediction methods where scale prediction is a manual and infrequent process and, in many cases, is based on outdated input data.

In certain embodiments, flowrate may be predicted using estimation of the flowrate across two or more points (e.g., creating a virtual flow meter or VFM), be it in a single pipe, a network or even a pump. In embodiments where the flowrate being determined is across a pump (e.g., the electric submersible pump 14), a VFM may be created using the pump's operating parameters, such as speed, temperature, pressure in, pressure out, and so forth. In certain embodiments, a VFM may be created from simulations or using data science models. In addition, in certain embodiments, the two techniques may be blended where, for example, synthetic data may be generated based on well model simulations, and this synthetic data may be fed to a machine learning algorithm, as described in greater detail herein. For example, in certain embodiments, synthetic data may be generated. In certain embodiments, a replica of the well may then be built inside the software, and simulation cases may be run using a range of operations of the electric submersible pump 14 observed for the well. In certain embodiments, these aggregated simulations may then be fed into an automated machine learning system, which (e.g., by passing the data through several machine learning techniques) enables the scale prediction and control system 42 described herein to determine the most accurate simulation for the present case.

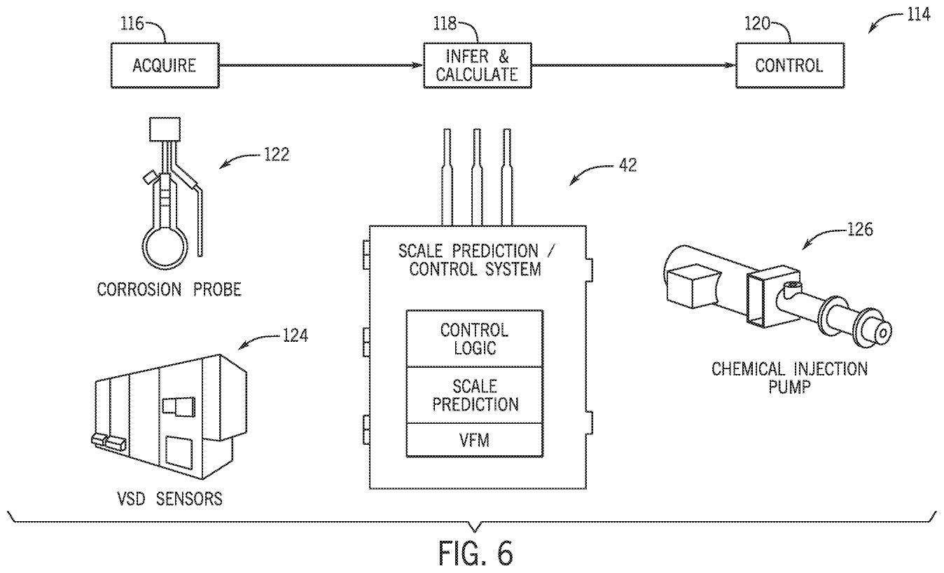

FIG. 6 illustrates a method 114 used in chemical injection operations using the scale prediction and control system 42. In general, the method 114 enables monitoring of the scale and corrosion risk through real-time data analysis and prediction instead of schedule. As illustrated in FIG. 6, the method 114 includes acquiring data 116, inferring and calculating parameters relating to scale and corrosion 118, and controlling equipment in accordance with the inferred and calculated parameters 120. In certain embodiments, the scale prediction and control system 42 may acquire data 116 relating to temperature and pressure at the wellhead 38, operating parameters of the electric submersible pump 14, corrosion rate, oil and water flowrates, water chemical composition and saturation index, and so forth. As described in greater detail herein, saturation index is a metric that indicates whether water will deposit minerals or keep them in solution. In certain embodiments, the corrosion rate may be collected from one or more corrosion probes 122 in substantially real-time during operations. In addition, in certain embodiments, the speeds of the pumps described herein (e.g., pumps of the 12 and/or the electric submersible pump 14) may be detected by variable speed drive (VSD) drive sensors 124 in substantially real-time during operations. Conversely, the water chemical composition may be sporadic, as it may require samples to be sent to a laboratory for analysis and returned, for example, in two weeks.

In certain embodiments, inferring and calculating parameters relating to scale and corrosion 118 may include determining flow rate and saturation index based on the inferred data. For example, in certain embodiments, flow rate may be predicted using a VFM based on data relating to operating parameters of the electric submersible pump 14. In addition, in certain embodiments, based on the wellhead temperature and pressure, the predicted flowrate, and the water chemical composition, the saturation index may be predicted using a model as described in greater detail herein. Then, the collected or inferred data may be converted into insights, which may be used to determine the rate at which the chemical injection pumps 126 of the chemical injection system 12 should inject chemicals into the well. These determined optimum chemical injection rates may then be communicated to the chemical injection pumps 126 of the chemical injection system 12 to control 120 operation of the chemical injection system 12.

As such, the embodiments described herein overcome the deficiencies of conventional corrosion and scale monitoring methods by moving to a more proactive approach by developing a repeatable framework of steps that can be validated on test wells, but also scaled up for larger commercial deployment in the future. In particular, the embodiments described herein are established by several beneficial changes with respect to such conventional corrosion and scale monitoring methods including, but not limited to:
Understanding which data is required at a higher frequency than conventional methods. For corrosion, it has been determined that two key data sets are produced water rate and corrosion rate. For scale, produced water rate, pressure, and temperature changes have been determined to have the largest impact on the risk of scale precipitating.
Determining which of the data may be made available by digitally connecting existing equipment. In certain embodiments, the scale prediction and control system 42 may take the form of an IoT (Internet of Things) device configured to integrate and process equipment data at the edge. In addition, the electric submersible pumps 14 enable access to downhole pressure and temperature data by connecting directly to controllers of the electric submersible pumps 14. In certain embodiments, certain surface sensors 28 may also be used to detect wellhead temperature and pressure.
Identifying where predictive models may be implemented to bridge data gaps that exist in conventional methods. Flow rate, corrosion risk, and scale precipitation risk were identified as variables of relative importance. Edge applications developed in the scale prediction and control system 42 described herein enable management of the whole modeling cycle: data gathering, model building, calibration, and results.
Procuring and installing additional digitally-enabled equipment to facilitate the embodiments described herein. In particular, it was determined that existing chemical injection pumps should be replaced with new chemical injection pumps that include a variable speed controller to allow for precise monitoring and control. Additionally, it was determined that electrical resistance (ER) corrosion probes, with a wireless transmitter, are very beneficial to provide surface corrosion rates in substantially real-time.
Developing data ingestion methods to incorporate historical data (e.g., relating to chemistry analysis results and well test data stored in production data management systems (PDMSs)). The water chemistry is needed for the scale prediction, and well test data is needed for ongoing calibration of the VFM.
Processing data as close to the equipment as possible and implement a closed loop control system. An edge application was developed on the scale prediction and control system 42 to process data in substantially real-time, the produced water rate (e.g., from the VFM described herein), the scale prediction (e.g., from the machine learning model described herein or other software being at least partially executed in the cloud), the corrosion rate (e.g., from the wireless ER corrosion probes), and the current chemical injection rate (e.g., from the chemical injection pumps of the chemical injection system 12). A recommended chemical injection rate may be output and, if it different than the current injection rate, may be presented in the cloud application as an insight that could be approved manually or automatically, and the new injection rate setpoint may be fed through the IIoT gateway, to a controller of the chemical injection system 12 to adjust operating parameters of the chemical injection pumps accordingly.
Developing a cloud-based interactive visualization application to provide end user full visibility and remote-control capabilities. This allows authenticated users to log into a secure and collaborative environment that enables visualization of real-time data from connected equipment, results of edge-processed calculations, and data ingested from existing PDMSs. Additionally, this is where automatically generated insights regarding changes in flow conditions and resulting chemical injection recommendations may be viewed and approved either manually (e.g., remotely) or automatically.

As such, the task of transforming this workflow into a real-time solution requires real-time data, most of which has been made available directly from field instrumentation or data-driven and physics-based models, as described in greater detail herein, that generate information and insights at a higher frequency. The calculation of target inhibitor injection rates uses the produced water rate and inhibitor concentration as inputs, as described above. The definition of target concentrations is specific for every flow assurance type.

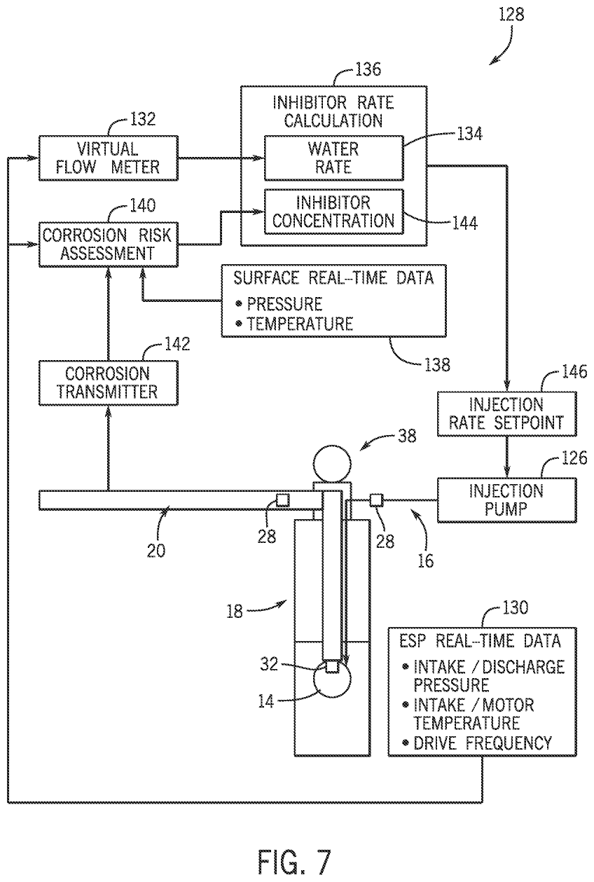

FIG. 7 illustrates a workflow 128 for determining a target corrosion inhibitor injection rate, and setting the determined target corrosion inhibitor injection rate in the chemical injection system 12. As illustrated, in certain embodiments, ESP real-time data 130 may be collected, for example, via downhole sensors 32 associated with an electric submersible pump 14, and delivered to a VFM 132 (e.g., which may be executed by the scale prediction and control system 42 described herein), which uses the ESP real-time data 130 as inputs to determine a produced water rate 134, which may in turn be used as an input into an inhibitor rate calculation module 136 (e.g., which may be executed by the scale prediction and control system 42 described herein). As illustrated, in certain embodiments, the ESP real-time data 130 may include intake pressure into the electric submersible pump 14, discharge pressure from the electric submersible pump 14, intake temperature into the electric submersible pump 14, temperature of a motor of the electric submersible pump 14, drive frequency of the motor of the electric submersible pump 14, and so forth.

In addition, in certain embodiments, surface real-time data 138 (e.g., pressure, temperature, flow rate, and so forth, for example, of the produced fluid 20) may be collected, for example, via surface sensors 28, and delivered to a corrosion risk assessment module 140 (e.g., which may be executed by the scale prediction and control system 42 described herein). In addition, in certain embodiments, a corrosion transmitter 142 (e.g., of a corrosion probe 122) may deliver a corrosion rate (e.g., as determined using the produced fluid 20) detected by the associated corrosion probe 122 to the corrosion risk assessment module 140. In addition, in certain embodiments, the ESP real-time data 130 may also be delivered to the corrosion risk assessment module 140. In certain embodiments, the corrosion risk assessment module 140 may use the surface real-time data 138, the corrosion rate, and the ESP real-time data 130 as inputs to determine an inhibitor concentration 144, which may in turn be used as an input into the inhibitor rate calculation module 136.

In certain embodiments, the inhibitor rate calculation module 136 may use the produced water rate 134 and the inhibitor concentration 144 to determine an injection rate setpoint 146, which may be transmitted (e.g., by the scale prediction and control system 42) to the chemical injection pumps 126 of the chemical injection system 12 to adjust the injection rate of the chemicals 16 from the chemical injection pumps 126 into the well 18.

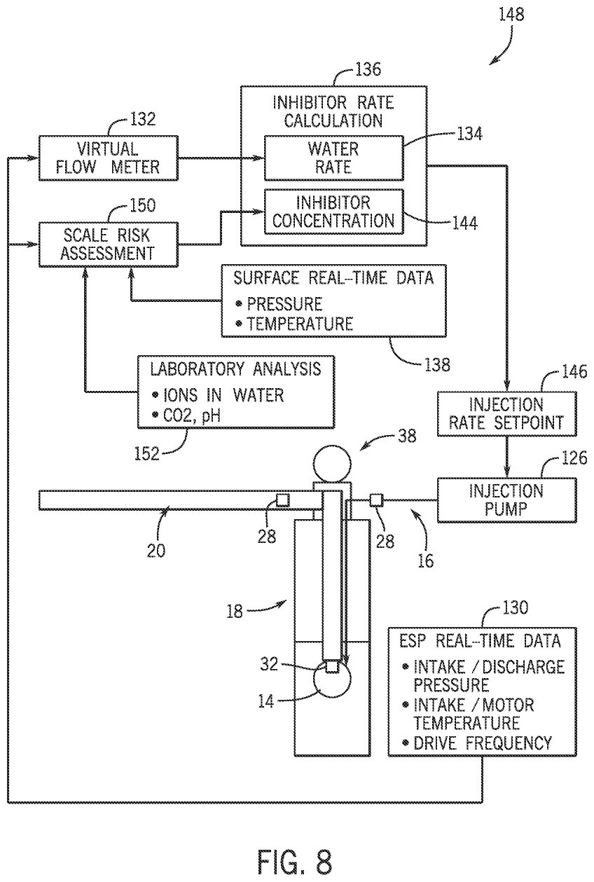

FIG. 8 illustrates a workflow 148 for determining a target scale inhibitor injection rate, and setting the determined target scale inhibitor injection rate in the chemical injection system 12. As illustrated, in certain embodiments, the ESP real-time data 130 may be collected, for example, via downhole sensors 32 associated with an electric submersible pump 14, and delivered to the VFM 132 (e.g., which may be executed by the scale prediction and control system 42 described herein), which uses the ESP real-time data 130 as inputs to determine the produced water rate 134, which may in turn be used as an input into an inhibitor rate calculation module 136 (e.g., which may be executed by the scale prediction and control system 42 described herein).

In addition, in certain embodiments, the surface real-time data 138 (e.g., pressure, temperature, flow rate, and so forth, for example, of the produced fluid 20) may be collected, for example, via surface sensors 28, and delivered to a scale risk assessment module 150 (e.g., which may be executed by the scale prediction and control system 42 described herein). In addition, in certain embodiments, laboratory analysis data 152 (e.g., sporadic analysis of the produced fluid 20, as described in greater detail herein) may be delivered to the scale risk assessment module 150. As illustrated, in certain embodiments, the laboratory analysis data 152 may include ions in produced water, carbon dioxide (CO₂) in the produced water, pH of the produced water, and so forth. In addition, in certain embodiments, the ESP real-time data 130 may also be delivered to the scale risk assessment module 150. In certain embodiments, the scale risk assessment module 150 may use the surface real-time data 138, the laboratory analysis data 152, and the ESP real-time data 130 as inputs to determine the inhibitor concentration 144, which may in turn be used as an input into the inhibitor rate calculation module 136.

In certain embodiments, the inhibitor rate calculation module 136 may use the produced water rate 134 and the inhibitor concentration 144 to determine the injection rate setpoint 146, which may be transmitted (e.g., by the scale prediction and control system 42) to the chemical injection pumps 126 of the chemical injection system 12 to adjust the injection rate of the chemicals 16 from the chemical injection pumps 126 into the well 18.

The objective of both workflows 128, 148 of FIGS. 7 and 8 is to define an optimized injection rate setpoint 146 for the chemical injection system 12. One of the data requirements for the workflows 128, 148 is the production rate of the well 18. As the flow rate is generally measured sporadically, developing a solution to calculate it in substantially real-time was necessary. The VFM 132 uses the relation between flow rate and differential pressure that comes with every pump curve. This relationship is commonly available from catalog pump curves built at standard conditions of 60 Hz, one stage, and fluid specific gravity equal to 1.0. In certain embodiments, the developed model corrects the catalog pump curves based on the actual number of stages, operating frequency, and specific gravity, among other parameters. In certain embodiments, an edge version may be used to make these corrections. The model ingests the real-time data of ESPs downhole sensors 32 along with basic black-oil fluid properties, and delivers liquid and water rates that feed the inhibitor rate calculation module 136.

Another parameter that is needed is the inhibitor concentration. In the case of the corrosion workflow 128, the corrosion risk assessment module 140 defines the optimum inhibitor concentration based on direct measurement of corrosion rate at the surface 30 and indirect calculations of downhole conditions, whereas in the case of the scale workflow 148, the scale risk assessment module 150 defines the optimum inhibitor concentration based on based on laboratory analysis data 152 and indirect calculations of downhole conditions. In general, the idea behind using two workflows 128, 148 is to protect the production system 10 against worst-case scenarios.

In addition, in the case of the corrosion workflow 128, an electrical resistance (ER) corrosion transmitter 142 delivers real-time direct measurement of corrosion rate at the surface 30. However, this measurement alone could not be representative of the general corrosion in the well 18. As such, a corrosion risk assessment module 140 was specifically developed to calculate a corrosion profile. In certain embodiments, the corrosion risk assessment module 140 calculates surface, downhole, and maximum corrosion rate in the well 18, offering the option to calibrate against field data.

The scale risk assessment module 150 functions slightly differently due to the lack of instrumentation to detect scale in substantially real-time. Hence, the scale risk assessment module 150 calculates the risk assessment represented by the saturation index both on surface and downhole. In the same way, the production system 10 will get protected against the highest saturation index regardless of where it takes place. In certain embodiments, the scale prediction model uses a thermodynamic model that calculates the saturation index and the precipitation volume of different scale species, depending on the water composition and system properties. In certain embodiments, the scale prediction model used ingests the water analysis results (e.g., the laboratory analysis data 152) along with real-time pressure and temperature from surface and downhole sensors 28, 32 to calculate real-time saturation index.

It has been observed that the embodiments described herein improve chemical injection precision (e.g., as compared to conventional systems and methods) through real-time monitoring and control. For example, it has been observed that actual injection rate vs. target injection rate compliance increases from 45% to 99%, ensuring continuous and optimal treatment. Part of this improvement is because chemical injection rates may be adjusted automatically, for example, every 5 minutes as opposed to weekly, or even monthly, as with conventional systems and methods.

In addition, significant reductions have been observed in the time between insight and action. Elapsed time from detection of risk to performing chemical adjustment has been observed to decrease by approximately 99%. Conventional manual monitoring workflows that are typically performed monthly may now be run every minute by the scale prediction and control system 42, enabling quick detection of relevant system changes and fully automatic chemical injection optimization. The real-time predictive models for virtual flow metering and scale prediction described herein have also been validated against manual methods, producing results that are within 3%, but that require no manual intervention.

Regarding environmental factors, with the fully automatic and remotely monitored chemical injection system 12, the CO₂ footprint generated by vehicles used for field visits has been observed to be reduced by more than 90%, as the system minimizes the commuting of field personnel to set injection rates and confirm equipment status. In addition, driving is the single biggest safety risk that people face in the field daily. The embodiments described herein reduce required field trips and, as such, reduce the exposure to such risk.

In addition, early economic feasibility analysis shows that by investing in the closed loop monitoring and control system described herein and reducing corrosion- and scale-related failures by just 10% per year could lead to 100% recovery of initial investment in the first year, and 500% in the first five years.

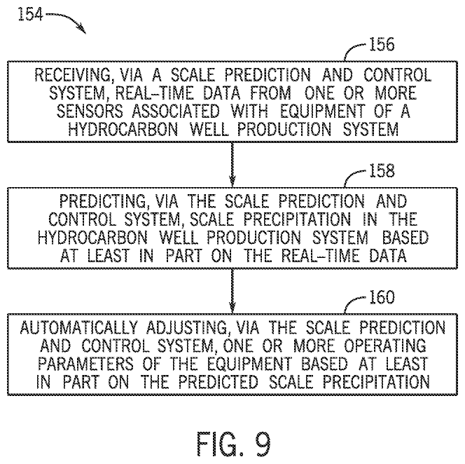

FIG. 9 is a flow diagram of a method 154 for using the scale prediction and control system 42. As illustrated, in certain embodiments, the method 154 includes receiving, via the scale prediction and control system 42, real-time data from one or more sensors 28, 32 associated with equipment 56, 58 of a hydrocarbon well production system 10 (block 156). In addition, in certain embodiments, the method 154 includes predicting, via the scale prediction and control system 42, scale precipitation in the hydrocarbon well production system 10 based at least in part on the real-time data (block 158). In addition, in certain embodiments, the method 154 includes automatically adjusting, via the scale prediction and control system 42, one or more operating parameters of the equipment 56, 58 based at least in part on the predicted scale precipitation (block 160).

In addition, in certain embodiments, automatically adjusting, via the scale prediction and control system 42, the one or more operating parameters of the equipment includes determining, via the scale prediction and control system 42, a scale inhibitor injection rate setpoint based at least in part on the predicted scale precipitation; and automatically adjusting, via the scale prediction and control system 42, a speed of one or more chemical injection pumps 126 of a chemical injection system 12 in accordance with the scale inhibitor injection rate setpoint.

The specific embodiments described above have been illustrated by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

In the claims, means-plus-function clauses are intended to cover the structures described herein as performing the recited function and not only structural equivalents, but also equivalent structures. Thus, for example, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words “means for” together with an associated function.

1. A scale prediction and control system, comprising:
one or more processors and storage media comprising processor-executable instructions that, when executed by the one or more processors, cause the one or more processors to:
receive real-time data from one or more sensors associated with equipment of a hydrocarbon well production system;
predict scale precipitation in the hydrocarbon well production system based at least in part on the real-time data; and
automatically adjust one or more operating parameters of the equipment based at least in part on the predicted scale precipitation.

2. The scale prediction and control system of claim 1, wherein automatically adjusting the one or more operating parameters of the equipment comprises:
determining a scale inhibitor injection rate setpoint based at least in part on the predicted scale precipitation; and
automatically adjusting a speed of one or more chemical injection pumps of a chemical injection system in accordance with the scale inhibitor injection rate setpoint.

3. The scale prediction and control system of claim 1, wherein the processor-executable instructions, when executed by the one or more processors, cause the one or more processors to:
infer additional real-time data from a first machine learning model using simulation algorithms; and
predict the scale precipitation in the hydrocarbon well production system based at least in part on the additional real-time data.

4. The scale prediction and control system of claim 3, wherein the first machine learning model is configured to estimate the additional real-time data using inputs from one or more downhole sensors disposed downhole within a well of the hydrocarbon well production system.

5. The scale prediction and control system of claim 3, wherein a second machine learning model is a neural network model that computes saturation index and precipitation amount using real-data received from one or more downhole sensors disposed downhole within a well of the hydrocarbon well production system, real-time data received from one or more surface sensors disposed at a surface of the well of the hydrocarbon well production system, and an output of the first machine learning model.

6. The scale prediction and control system of claim 1, wherein the one or more sensors comprise one or more downhole sensors disposed downhole within a well of the hydrocarbon well production system.

7. The scale prediction and control system of claim 6, wherein the real-time data comprises data relating to operating parameters of an electric submersible pump disposed downhole within the well of the hydrocarbon well production system.

8. The scale prediction and control system of claim 6, wherein the real-time data comprises data relating to a reservoir through which the well of the hydrocarbon well production system extends.

9. The scale prediction and control system of claim 1, wherein the one or more sensors comprise one or more surface sensors disposed at a surface of a well of the hydrocarbon well production system.

10. The scale prediction and control system of claim 9, wherein the real-time data comprises data relating to pressure, temperature, flow rate, or some combination thereof, of produced fluid that is produced from the well of the hydrocarbon well production system.

11. The scale prediction and control system of claim 1, wherein the one or more sensors comprise a corrosion probe configured to determine a corrosion rate based at least in part on one or more chemical properties of produced fluid that is produced from a well of the hydrocarbon well production system

12. The scale prediction and control system of claim 1, wherein the processor-executable instructions, when executed by the one or more processors, cause the one or more processors to determine a water rate using a virtual flow meter.

13. The scale prediction and control system of claim 1, wherein the processor-executable instructions, when executed by the one or more processors, cause the one or more processors to synchronize operation of a submersible pump with a status of chemical injection equipment.

14. A method, comprising:
receiving, via a scale prediction and control system, real-time data from one or more sensors associated with equipment of a hydrocarbon well production system;
predicting, via the scale prediction and control system, scale precipitation in the hydrocarbon well production system based at least in part on the real-time data; and
automatically adjusting, via the scale prediction and control system, one or more operating parameters of the equipment based at least in part on the predicted scale precipitation.

15. The method of claim 14, wherein automatically adjusting, via the scale prediction and control system, the one or more operating parameters of the equipment comprises:
determining, via the scale prediction and control system, a scale inhibitor injection rate setpoint based at least in part on the predicted scale precipitation; and
automatically adjusting, via the scale prediction and control system, a speed of one or more chemical injection pumps of a chemical injection system in accordance with the scale inhibitor injection rate setpoint.

16. The method of claim 14, comprising inferring, via the scale prediction and control system, additional real-time data from a first machine learning model using simulation algorithms.

17. The method of claim 16, wherein the first machine learning model is configured to estimate the additional real-time data using inputs from one or more downhole sensors disposed downhole within a well of the hydrocarbon well production system.

18. The method of claim 16, wherein a second machine learning model is a neural network model that computes saturation index and precipitation amount using real-data received from one or more downhole sensors disposed downhole within a well of the hydrocarbon well production system, real-time data received from one or more surface sensors disposed at a surface of the well of the hydrocarbon well production system, and an output of the first machine learning model.

19. The method of claim 14, comprising determining, via the scale prediction and control system, a water rate using a virtual flow meter.

20. A scale prediction and control system, comprising:
one or more processors and storage media comprising processor-executable instructions that, when executed by the one or more processors, cause the one or more processors to:
receive real-time data from one or more sensors associated with equipment of a hydrocarbon well production system;
utilize cloud-based computing software to predict scale precipitation in the hydrocarbon well production system based at least in part on the real-time data; and
automatically adjust one or more operating parameters of the equipment based at least in part on the predicted scale precipitation.
